(19) United States
(12) Patent Application Publication
(10) Pub. No.: US 2001/0014218 A1
(43) Pub. Date: Aug. 16, 2001

(54) Photographic film cutter device

(76) Inventor: Vanni Leopoldo Beggiao, Padova (IT)

Correspondence Address: WEINGARTEN, SCHURGIN, GAGNEBIN, & HAYES, LLP, TEN POST OFFICE SQUARE, BOSTON, MA, 02109, US

(21) Appl. No.: 09/776,323

(22) Filed: Feb. 2, 2001

(30) Foreign Application Priority Data
Feb. 3, 2000 (EP) 00 102 412.4
Jul. 25, 2000 (EP) 00 115 033.3

(51) Int. Cl. G03B 17/24; G03B 19/00

(52) U.S. Cl. 396/311; 396/429

(57) ABSTRACT

The present invention is directed to an arrangement for assigning photographic films of customer orders to the respective customer orders, so that the film batches can be assembled only in accordance with considering the format of the prints which have to be formed on the basis of the corresponding films, while the paper type or surface can be disregarded. To achieve this aim, an assignment section assigns the film portions cut from a film batch to envelopes in which the items of customer orders have been received by the photo lab, and in which the finished customer orders are sent by the photo lab back to the photo shop where the customer brought the undeveloped film for developing.

### CROSS REFERENCE TO RELATED APPLICATIONS

This application claims the priority of the European patent application No. 00 102 412.4-2217 filed on Feb. 3, 2000 and entitled “Photographic Web Cutter Device”.

The disclosure of this reference is incorporated in this application by reference.

### FIELD OF THE INVENTION

The present invention relates to the field of photo finishing laboratories and in particular to the field of large scale photo finishing labs. Preferably the present invention relates to an arrangement for assigning photographic films related to a plurality of customer orders according to claim 1. In addition, the present invention relates to a further arrangement of the same type as well as to a process for assigning photographic films to the respective customer orders.

### BACKGROUND OF THE INVENTION

In large scale photo finishing labs, it is common that a huge number of customer orders are received in the shape of exposed, undeveloped films. These films are spliced together to provide a reel or roll of undeveloped films, called a film batch. These undeveloped films are then developed and processed in accordance with the special wishes or instructions of the customers. According to these wishes, the photographs of one film can be exposed on photosensitive print paper of different types or qualities.

According to the customers' wishes, the photographs of one film can be exposed on photosensitive print paper of different types or qualities. In addition, the customer may order different formats, for instance, this could mean in an extreme case that a customer orders that a particular number of photographs of his film be exposed on matt paper and another number of photographs be exposed on glossy paper, and furthermore he wishes a number of photographs of the same film to be exposed on royal print paper. Usually, the different paper qualities are termed “matt”, “glossy” and royal. Other paper qualities may arise or be chosen by the customer. However, it is more usual that a customer orders one film to be exposed on one special kind of paper quality, while another customer chooses another type of paper quality.

Accordingly, the different orders of the customers can be exposed on different print paper types. Later, it will be necessary to assign the particular negative films of the various customers to the finished prints on the paper of different types or surfaces.

It is advantageous to splice together the different film negatives of huge number of films to expose the film negatives on photosensitive paper of different qualities of surfaces in accordance with the wishes or instructions of the customer.

Films to be developed arrive in the lab in an envelope which can be identified usually by two bar codes: the first code identifies the dealer or photo shop, while the second identifies the specific order, i.e. the customer, correspondingly, a customer can ask in the photo shop for his specific order by means of a receipt including these e.g. two codes. Moreover, in addition to the usual dealer envelope, it is also possible to use a so-called Eurocombi envelope.

In the past, it was usual that the operator in the photo shop or the dealer placed the customer order in an envelope, (so-called dealer envelope). This dealer envelope had on it all the recognition dates (e.g. the two bar codes) and the processing information or instructions. After the customer order was completed, all items of this order were again assigned to the original dealer envelope and this envelope was placed into a wallet and delivered to the dealer to be handed over to the customer.

In contrast to the dealer envelope, the Eurocombi envelope or a comparable type of envelope for the specific needs in the US allows all items to be placed into the Eurocombi envelope during the submission phase from the photo shop or dealer to the lab and back from the lab to the photo shop or dealer. Accordingly, with the Eurocombi envelope, the over-all process is less diversified and, thus, less expensive.

The customer may select from a considerable variety of different processing possibilities regarding paper types, surfaces and formats. This selection is performed by marking a specific box on the Eurocombi envelope.

When the material arrives at the lab, it is sorted to create homogeneous orders depending on the customer request e.g. 10×15 on glossy paper, 10×15 on matt paper, 10×15 on royal paper, 13×18 on matt . . . ).

Homogeneous customer orders which will have to be processed the same way are spliced together to a film batch to form a continuous roll of typically 100-200 orders.

On the splice material or splice paper, a code is printed which is associated to a specific customer.

Then, the film is developed and exposed on the selected paper.

### SUMMARY OF THE INVENTION

The increase in digital service offers (CD, floppy, index print . . . ) and the possibility of being more flexible on marketing offers implies a fragmentation of batches. Accordingly, there is a reduction in the number of films which have to be processed the same way meaning that the batches are becoming smaller. Smaller batches and thus a larger number of batches increases the handling costs for the photo lab.

Therefore, it is an object of the present invention to reduce the number of divisions in such a way as to increase the sizes of the batches dimensions/productivity.

One purpose of the invention is to reduce the selection only to the paper width and not to the paper type or surface. According to the invention, this is now possible due to the availability of new digital devices, e.g. film scanners, data devices managers and digital printers etc., by using the Eurocombi envelope.

The present invention provides an arrangement for assigning photographic films of customer orders. This arrangement includes a magazine for receiving a film batch consisting of films from many customers being exposed on at least two different paper types and/or types of paper with different surfaces. The arrangement further includes a cutter portion for cutting film portions from said film batch, said film portions being distinguishable from each other by a match code which is related to a particular customer order. In addition, at least one sensor means for sensing said match code is located in the arrangement according to the invention.

The feature which is believed new is directed to an assignment section which assigns conveyor and/or storage units, particularly envelopes (Eurocombi envelopes) or other US-specific types of envelops, provided with match codes related to said different paper types and/or different types of paper with different surfaces and/or match codes related to particular customer orders, to the paper types and/or paper surfaces. This means, that the conveyor and/or storage units can be assigned to customer orders with instructions to expose the film on said different types of paper or paper surfaces. Then, it is no longer necessary to create film batches for different paper types and paper surfaces as well as for different formats, but only for the different formats. This is particularly advantageous if film batches have to be created for those formats which are usually preferred by the customers because of the price or the custom.

Of course, the invention can also be used in connection with other types of envelops which serve specific needs of other countries like Canada, Japan, China, and so on.

It is advantageous if the arrangement according to the invention is provided with a feeder section for feeding said conveyor and/or storage units, in particular said envelopes or Eurocombi envelopes. The feeder section can receive a large number of Eurocombi envelopes which can be sorted to each fit to one paper type or paper surface.

In addition, the assignment section of the arrangement according to the invention can include several compartments or bins for receiving conveyor and/or storage units, in particular envelopes or Eurocombi envelopes, assigned to different paper types or types of paper with different surfaces.

Accordingly, it is possible to sort the envelopes or Eurocombi envelopes of different customer orders in the compartments or bins, so that the film and/or paper photographs or further items directed to particular customer orders can be assigned to the envelopes in the compartments or bins, which are sorted in accordance with the paper type or a surface chosen by the customer when depositing his order in the photoshop.

Accordingly, the number of film batches can be reduced and thus the handling costs per film batch and, owing to this, per customer can be reduced.

It is a useful feature to locate an assignment sensor for detecting a code and/or said match code to achieve information from this code which of said conveyor and/or storage units, in particular, a Eurocombi envelope from said feeder section has to be assigned to which of said several compartments or bins. The match code can for instance be transmitted from a batch handling server computer of the photo finishing laboratory or can be read directly from the conveyor and/or storage units, e.g. said Eurocombi envelope and/or the splicer portions between the film portions of a said film batch to be cut. In principle, the assignment sensor only needs information regarding the paper type or the paper surface to be able to assign the right items of a particular customer order to the appropriate compartment or bin. Accordingly, if the Eurocombi envelope includes a cross in the mark for a particular paper type or a surface already on the basis of the detection of this mark, it is possible to assign a particular envelope to the matching compartment or bin. Accordingly, in this situation, it is not necessary to be aware of the complete match code of a customer order. It is an advantageous embodiment of this invention if said assignment section includes conveyor paths with at least one selector or joints device to guide said conveyor and/or storage units, e.g. said Eurocombi envelopes. Accordingly, starting from one particular location in the assignment section of the arrangement according to the invention, e.g. the feeder section, the units or Eurocombi envelopes can be directed to the matching compartment or bin, which is assigned to one paper type or paper surface.

According to another advantageous embodiment, the arrangement according to the invention further includes a packer section for packaging said cut film portions into said conveyor and/or storage units, e.g. said Eurocombi envelopes, in accordance with said match codes on said film portions and on said units, in particular, said Eurocombi envelopes.

Accordingly, it is a very advantageous embodiment, if the film portions spliced together to a film batch can be cut, introduced by the packer section into the matching Eurocombi envelopes, and said envelopes with the assigned film portion or portions can be directed via conveyor path and selector or joints devices to the corresponding compartments or bins to be stored there until the correct paper prints are available to be assigned to the correct Eurocombi envelope with the matching film portions of the respective customer order.

Of course, the compartments or bins can be very large to enable storage of large numbers of units or Eurocombi envelopes containing films on the one hand, and on the other hand, it is also possible to remove a full compartment or bin and exchange this against an empty one while the full one being stored as long as it takes to provide the corresponding paper prints to be assigned to the right envelopes.

According to a further aspect of the present invention, an arrangement for processing photographic films of customer orders comprises a film processing section for processing batches of films, each batch being constituted of a number of films and/or film negatives, and a film scanning section for achieving image data to be processed, i.e. to be exposed on photosensitive paper. Furthermore, the arrangement includes a paper print generating section and a batch managing server computer for controlling the process flows of the customer orders being related to match codes. According to the invention, this arrangement for processing photographic films of customer orders includes an assignment arrangement according to the invention and/or according to one or several subclaims.

In accordance with one advantageous embodiment of this second aspect of the invention, the paper print generating section includes a print packer means assigning prints being related to said match codes to said conveyor and/or storage units and in particular to said envelopes (Eurocombi envelopes).

The arrangement according to the invention by means of said batch managing server computer allows that the items related to a particular customer order are assigned to the matching conveyor and/or storage unit, e.g. said Eurocombi envelope.

According to another aspect of the present invention, a process for processing photographic films of customer orders each being related to a special match code in a photo laboratory, includes the following steps: First of all, already received envelopes with films assigned to particular customer orders, are emptied to acquire the photographic films. Then, several developed or undeveloped photographic films are spliced together to provide a film batch. Undeveloped film batches are developed. The developed film batches are scanned to provide digital image data to be processed and/or exposed on photo prints of several types of photographic paper or paper surfaces, wherein said image data and said prints are assignable to said corresponding match codes of respective customer orders. Then, in a further step, said film batches are loaded into a film cutter device to be cut into film portions which are assignable to said corresponding match codes. Finally, the film portions are assigned to their corresponding customer orders on the basis of the match codes, i.e. to the received envelopes or Eurocombi envelopes. Furthermore, the matching photo prints and other items in accordance with said processing instructions stemming from the respective customer, and all other items which are necessary to deal with the needs e.g. of the dealer or photo shop can be assigned to the corresponding envelope and thus to the matching film portions of a particular customer order.

In addition, with this aspect of the invention, film portions belonging to particular customer orders can be stored in the matching envelopes or Eurocombi envelopes, until further items of said particular customer orders are available, i.e. are processed and/or completed to be delivered to the customer.

### BRIEF DESCRIPTION OF THE DRAWINGS

In the following, preferred embodiments in accordance with the present invention are described based on the drawings attached hereto. In the drawings and the related specification also further features, advantages and achievements in accordance with the present invention are disclosed, wherein:

FIG. 1 shows a schematic view of an arrangement for assigning photographic films of customer orders in accordance with the invention; and

FIG. 2 shows a schematic view of an overall photo finishing laboratory which could also employ an arrangement which is in accordance with the invention.

### DETAILED DESCRIPTION OF THE PREFERRED EMBODIMENTS

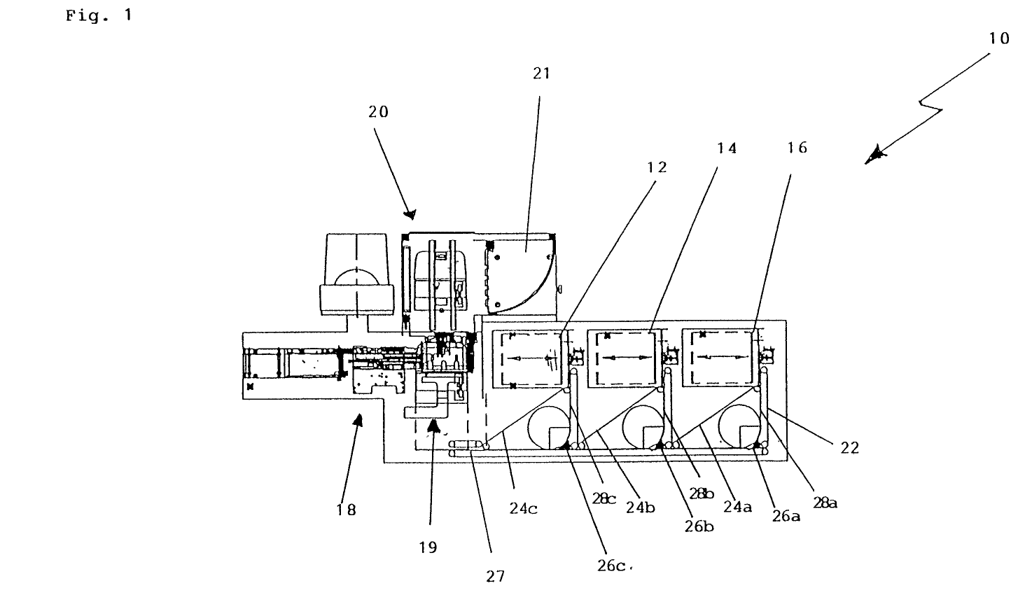

In FIG. 1, an arrangement for assigning photographic films of customer orders is depicted, which arrangement is in compliance with the gist of the present invention.

The arrangement 10 according to FIG. 1 includes a negative cutter portion 18 which is able to receive one or several film batches to be cut away from the film batch to be assigned to those envelopes or Eurocombi envelopes having the same match codes (e.g. two bar codes).

The arrangement 10 includes one feeder section 21, into which large numbers of envelopes or Eurocombi envelopes can be loaded. The Eurocombi envelopes from the section 21 are supplied to a feeder and recognition section 20, which supplies Eurocombi envelopes to be filled with negative films cut away from the particular film batch. The corresponding film portion can be recognized in the cutter portion 18 on the basis of the splicer portions between two consecutive films of a film batch. These splicer portions support the match codes on the basis of which a negative film can be assigned to a particular customer order and to instructions for processing the corresponding film. These instructions are related to the format and the paper type or paper surface of the photo prints which are the final product leaving the photo lab.

In a packer section 19, the cut film portions are introduced into the Eurocombi envelopes coming from the feeder 21. Afterwards, in accordance with the paper type and/or paper surface of the photo prints which have been created on the basis of the respective films, the envelopes together with the films therein are guided to compartments or bins 12, 14, 16. Between the packer section 19 and the compartments or bins 12, 14, 16 several conveyor paths formed by endless conveyor belts 24a, 24b, 24c are arranged to transport the Eurocombi envelopes to the bins 12, 14, 16.

To direct the matching envelopes to the corresponding bins 12, 14, 16, selector or joints devices 26a, 26b, 26c are located at the main conveyor path 27 which transports the envelopes with the films to the branch conveyor paths 28a, 28b, 28c, where the selector or joints devices 26a, 26b, 26c are located to divert the right envelope or envelopes to the appropriate compartments or bins 12, 14, 16.

If the photo print batches corresponding to the envelopes and films in a particular bin or compartment (one of those 12, 14, 16) are finished, the movement of the conveyor belts can be reversed and the corresponding envelopes containing the matching films can be supplied to be assigned to the finished photo prints.

Of course, it is also possible to remove the compartments or bins 12, 14, 16 to transport them to another forking or handling section in the photo lab to assign the right envelopes or Eurocombi envelopes to the matching photo prints so that the customer orders can be completed in accordance with their instructions.

Usually, the paper types on which film negatives are exposed are consisting of the types matt, royal and glossy. Accordingly, the compartments or bins 12, 14, 16 are directed to these three paper types or paper surfaces. In the feeder section 21, the Eurocombi envelopes are fed in sequence, this sequence corresponding to films in a film batch which have to be cut in the cutter portion 18.

The packer section 19 introduces the negative film portions into the matching Eurocombi envelopes stemming from the feeder section 21, and the envelopes are guided to the matching compartment or bin 12, 14, 16 in accordance with the paper type or paper surface which is dedicated thereto.

Accordingly, while the films and the Eurocombi envelopes in the cutter portion 18 and the feeder section 21, respectively, are in a fixed sequence, this sequence is no longer valid with respect to the envelopes and films packed in the compartments or bins 12, 14, 16.

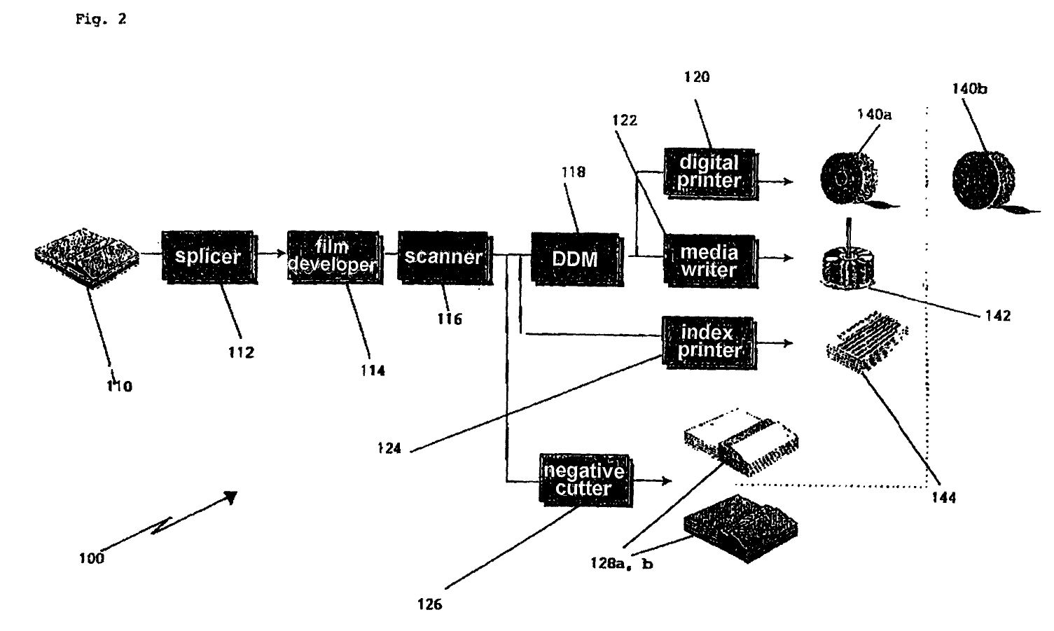

In FIG. 2, a photo 2 and a photo lab 100 are shown schematically. The reference number 110 symbolises a huge number of customer orders in envelopes or Eurocombi envelopes which are supplied to the photo lab 100. The films only have to be separated according to the formats, while the paper types or paper surfaces on which the films have to be exposed are no criteria for forming homogeneous film batches.

The image data from the film scanner can be processed in accordance with several software-related criteria to promote the quality of the final product, i.e. other paper prints or the image data on CD-ROMs 142 and the like. The processed image data can be stored in a digital data memory 118 to be sent to a digital printer 124, which provides index prints 144 for each of the customer orders. After the film batch has been scanned the roll representing the negative film batch can be delivered to a negative cutter 126, which in accordance with match signals present on the splice portions of the negative film batch, can send control data to a photo print cutter in accordance with the invention or which can send these control data to a central laboratory computer or a central lab server, which controls a cutter device according to the invention to dispense and cut film sections which have to be assigned to particular envelopes and/or or paper prints assigned to particular customer orders.

On the basis of the image data stored in the memory 118, the digital printer is supplied with exposure orders which are related to a particular quality of a photosensitive paper type, for instance, royal, matt or glossy, which is actually present in the printer 120. Later, other image data can be transmitted from the memory 118 to the printer 120 if digital data have to be exposed on photosensitive paper material of another type, i.e., for instance, matt, glossy, etc.

The media writer 123 as well as the index printer 124 can use the image data for the respective one of the types of photosensitive paper which actually is processed in the digital printer 120.

Finally, several paper print batches 140a, 140b, etc. are, after development, ready to be assigned to the particular customer orders they stem from. Then, in accordance with the present invention, the paper print batches 140a, 140b etc. are entered into a cutter device and are cut into paper prints in relation to a film negative which is processed by the negative cutter 126, which can be configured like the negative cutter 10 of FIG. 1.

Finally, the correct prints from the paper print batches 140a, 140b are assigned to customer orders 128a, 128b represented by Eurocombi envelopes 128a, 128b, to which the corresponding negative films and Eurocombi envelopes can be assigned by the negative cutter 126, which might be represented by the arrangement according to FIG. 1.

In this preferred embodiment of the invenmation, the Eurocombi envelopes 110, sent to the lab by the photo shop, are also assigned to the finished customer orders and are represented by the reference numbers 128a, 128b.

1. Arrangement for assigning photographic films of customer orders, including:
magazines for receiving a film batch consisting of films from many customers being exposed on at least two different paper types and/or types of paper with different surfaces;
a cutter portion for cutting film portions from said film batch, said film portions being distinguishable from each other by match codes which are related to particular customer orders;
at least one sensor means for sensing said matching codes;
characterized by:
an assignment section which assigns conveyor and/or storage units, particularly envelopes (Eurocombi envelopes) provided with match codes related to said different paper types and/or different types of paper with different surfaces and/or match codes related to particular customer orders, to the paper types and/or paper surfaces.

2. Arrangement according to claim 1, comprising that said assignment section includes a feeder section for feeding said conveyor and/or storage units, in particular envelopes (Eurocombi envelopes).

3. Arrangement according to claim 1, comprising that said assignment section includes several compartments or bins for receiving conveyor and/or storage units, in particular envelopes assigned to different paper types or types of paper with different surfaces.

4. Arrangement according to claim 3, comprising that an assignment sensor for detecting bar and/or said match codes is provided to obtain information about of said conveyor and/or storage units, in particular envelopes (Eurocombi envelopes), have to be assigned from said feeder section (21) to which of said several compartments or bins (12, 14, 16).

5. Arrangement according to claim 1, comprising that said assignment section includes conveyor paths with at least one selector or joints device to guide said conveyor and/or storage units, e.g. envelopes (Eurocombi envelopes).

6. Arrangement according to claim 5, comprising that said conveyor paths are convey said conveyor and/or storage units, in particular envelopes (Eurocombi envelopes) from said feeder section to said compartments or bins in accordance with said match codes and/or codes detected by said assignment sensor.

7. Arrangement according to claim 1, wherein said arrangement including a packer section for packing said cut film portions into said conveyor and/or storage units, in particular envelopes (Eurocombi envelopes) in accordance with said match codes on said film portions and on said units, in particular envelopes (Eurocombi envelopes).

8. Arrangement for processing photographic films of customer orders, comprising:
a) a film processing section for processing batches of films, each batch being constituted of a number of films and/or film negatives, each batch particularly providing a homogeneous batch;
b) a film scanning section;
c) a paper print generating section;
d) a batch managing server computer for controlling the process flows of the customer orders being related to match codes;
characterized by
an assignment arrangement for assigning photographic films of customer orders, including:
magazines for receiving a film batch consisting of films from many customers being exposed on at least two different paper types and/or types of paper with different surfaces;
a cutter portion for cutting film portions from said film batch, said film portions being distinguishable from each other by match codes which are related to particular customer orders;
at least one sensor means for sensing said matching codes;
characterized by:
an assignment section which assigns conveyor and/or storage units, particularly envelopes (Eurocombi envelopes) provided with match codes related to said different paper types and/or different types of paper with different surfaces and/or match codes related to particular customer orders, to the paper types and/or paper surfaces.

9. Arrangement according to claim 8, comprising that said assignment section includes a feeder section for feeding said conveyor and/or storage units, in particular envelopes (Eurocombi envelopes).

10. Arrangement according to claim 8, comprising that said assignment section includes several compartments or bins for receiving conveyor and/or storage units, in particular envelopes assigned to different paper types or types of paper with different surfaces.

11. Arrangement according to claim 10, comprising that an assignment sensor for detecting bar and/or said match codes is provided to obtain information about of said conveyor and/or storage units, in particular envelopes (Eurocombi envelopes), have to be assigned from said feeder section to which of said several compartments or bins.

12. Arrangement according to claim 8, comprising that said assignment section includes conveyor paths with at least one selector or joints device to guide said conveyor and/or storage units, e.g. envelopes (Eurocombi envelopes).

13. Arrangement according to claim 12, comprising that said conveyor paths are convey said conveyor and/or storage units, in particular envelopes (Eurocombi envelopes) from said feeder section to said compartments or bins in accordance with said match codes and/or codes detected by said assignment sensor.

14. Arrangement according to claim 8, wherein said arrangement including a packer section for packing said cut film portions into said conveyor and/or storage units, in particular envelopes (Eurocombi envelopes) in accordance with said match codes on said film portions and on said units, in particular envelopes (Eurocombi envelopes).

15. Arrangement according to claim 8, characterized in that said paper print generating section includes a print packer means assigning prints being related to said match codes to said conveyor and/or storage units, in particular envelopes (Eurocombi envelopes), to complete customer orders.

16. Arrangement according to one of claims 8, characterized in that said batch managing server computer controls a section of said arrangement such that the items related to a particular customer order are assigned to the matching conveyor and/or storage unit, e.g. an envelope (Eurocombi envelope).

17. Arrangement according to one of claims 9, characterized in that said batch managing server computer controls a section of said arrangement such that the items related to a particular customer order are assigned to the matching conveyor and/or storage unit, e.g. an envelope (Eurocombi envelope).

18. Process for processing photographic films of customer orders, each being related to a special match code in a photo laboratory, including the following steps:
a) received envelopes with match codes are emptied to obtain the photographic films;
b) several undeveloped or developed photographic films are spliced together to provide a film batch;
c) undeveloped film batches are developed;
d) said developed film batches are scanned to provide digital image data to be processed and/or exposed on photo prints of several types of photographic paper or paper surfaces, said image data and said prints being assignable to said corresponding match code or codes;
e) said film batches are loaded into a film cutter device to be cut into film portions which are assignable to said corresponding match codes;
f) film portions are assigned to corresponding customer orders on the basis of the match codes on the received envelopes (Eurocombi envelopes).

19. Process according to claim 18, characterized in that said film portions belonging to particular customer orders are stored in the matching envelopes received until further items of said particular customer order are available, i.e. are processed and/or completed.
